(19) United States
(12) Patent Application Publication
(10) Pub. No.: US 2015/0081927 A1
(43) Pub. Date: Mar. 19, 2015

(54) METHOD FOR CONSTRUCTING INTERNET ADDRESS SCHEMES USING XML

(71) Applicant: Tsinghua University, Beijing (CN)

(72) Inventors: KE XU, Beijing (CN); LIANG ZHU, Beijing (CN); YOUJIAN ZHAO, Beijing (CN); MIN ZHU, Beijing (CN)

(21) Appl. No.: 14/485,766

(22) Filed: Sep. 14, 2014

(30) Foreign Application Priority Data
Sep. 17, 2013 (CN) 201310424944.7

(51) Int. Cl. H04L 29/12

(52) U.S. Cl. CPC H04L 61/2007
USPC 709/245

(57) ABSTRACT

In a method for constructing Internet protocol (IP) addresses using extensible markup language (XML), an XML schema associated with a predetermined type of Internet address schemes is defined using a universal description standard. The XML schema includes attribute elements covering core attributes of constructing the Internet address schemes. The attribute elements include: construct_method, representing a function constructing method for the Internet address schemes, which is an enumeration type stored in a function association table. The function association table stores a collection of function constructing methods and a collection of functions for constructing the Internet address schemes, each of which is associated with a corresponding function constructing method. Then, values of the attribute elements for constructing the Internet address schemes are input. Next, the values are resolved and the corresponding function is called to construct the Internet address schemes according to the values.

### CROSS-REFERENCE TO RELATED APPLICATION

This application claims priority to and benefits of Chinese Patent Application Serial No. 201310424944.7, filed with the State Intellectual Property Office of P. R. China on Sep. 17, 2013, the entire contents of which are incorporated herein by reference.

### FIELD

The present disclosure relates to technologies for constructing Internet address schemes, and more particularly to a method for constructing Internet address schemes using extensible markup language (XML).

### BACKGROUND

An Internet protocol (IP) address is a numerical label assigned to each device, such as a computer and a printer, participating in a computer network that uses the IP for communication. An IP address serves two principal functions: host or network interface identification and location addressing.

The designers of the IP defined an IP address as a 32-bit number and this system, known as IP version 4 (IPv4), is still in use today. However, due to the enormous growth of the Internet and the predicted depletion of available addresses, the address system cannot meet requirements any more.

As such, various new types of Internet address schemes, such as cryptographically generated addresses (CGA), named data networking (NDN), host identity protocol (HIP), and accountable Internet protocol (AIP), are proposed. However, as semantics constraints and construction methods of the new types of address schemes are different from each other, each new type of Internet address schemes requires a unique constructing method, which is inefficient for deployment and study of the new types of Internet address schemes.

### SUMMARY

According to an aspect of the present disclosure, a method for constructing Internet protocol (IP) addresses using extensible markup language (XML), an XML schema associated with a predetermined type of Internet address schemes is defined using a universal description standard. The XML schema includes attribute elements covering core attributes of constructing the Internet address schemes. The attribute elements include: construct_method, representing a function constructing method for the Internet address schemes, which is an enumeration type stored in a function association table. The function association table stores a collection of function constructing methods and a collection of functions for constructing the Internet address schemes, each of which is associated with a corresponding function constructing method. Then, values of the attribute elements for constructing the Internet address schemes are input. Next, the values are resolved and the corresponding function is called to construct the Internet address schemes according to the values.

In one embodiment, the attribute elements in addition include:

address_name, representing a name of the type of Internet address schemes;

address_list, representing an original Internet address string;

address_structure, representing Internet address structure;

address_blocks, representing the number of Internet address blocks;

address_prefix, representing a prefix length of the Internet address schemes; and

separator, representing a separator for connecting the Internet address blocks.

In one embodiment, the attribute element address_name is defined by users.

In one embodiment, the attribute element address_list is defined by users or automatically generated.

In one embodiment, restriction elements are used to restrain a length and size of the original Internet address string.

In one embodiment, the attribute element address_structure is restrained by enumeration values and used for designating the Internet address schemes as a flat structure or a hierarchical structure.

In one embodiment, the attribute element address_blocks is an integer with default value 1.

In one embodiment, the attribute element address_prefix is an integer and used for designating the prefix length of the Internet address schemes.

In one embodiment, wherein the attribute element separator is selected from the group consisting of “/”, “.”, and “:”.

In one embodiment, the function is defined by the users and associated with a corresponding function constructing method in the function association table.

In one embodiment, semantics constraints are applied to the attributes element of the Internet address schemes, the method further includes: checking the values for correctness and completeness according to semantics constraints in the schema, if pass, the method going to the resolving step and if no the method remaining in the inputting step.

In this method, various types of the Internet address schemes are analyzed to obtain common attribute elements of current and future types of the Internet address schemes. Thus, a universal description standard with almost complete semantics constraints is provided to construct different types of the Internet address schemes. Efficiency is increased.

Additional aspects and advantages of the embodiments of the present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of the disclosure will become apparent and more readily appreciated from the following descriptions taken in conjunction with the drawings in which:

FIG. 1 is a flow chart of a method for constructing Internet address schemes using XML, according to an embodiment of the present disclosure.

FIG. 2 shows an example of the XML schema according to the embodiment.

FIG. 3 shows an example of XML schema for IPv6 addresses according to the embodiment.

FIG. 4 shows a user interface for constructing HIP addresses after values are input but before the HIP addresses are finally constructed, according to an embodiment.

FIG. 5 shows the user interface for constructing the HIP addresses after the HIP addresses are constructed, according to the embodiment.

### DETAILED DESCRIPTION

Embodiments of the present disclosure will be described in detail in the following descriptions, examples of which are shown in the accompanying drawings, in which the same or similar elements and elements having same or similar functions are denoted by like reference numerals throughout the descriptions. The embodiments described herein with reference to the accompanying drawings are explanatory and illustrative, which are used to generally understand the present disclosure. The embodiments shall not be construed to limit the present disclosure.

Various embodiments and examples are provided in the following description to implement different structures of the present disclosure. In order to simplify the present disclosure, certain elements and settings will be described. However, these elements and settings are only by way of example and are not intended to limit the present disclosure. In addition, reference numerals may be repeated in different examples in the present disclosure. This repeating is for the purpose of simplification and clarity and does not refer to relations between different embodiments and/or settings. Furthermore, examples of different processes and materials are provided in the present disclosure. However, it would be appreciated by those skilled in the art that other processes and/or materials may be also applied. Moreover, a structure in which a first feature is “on” a second feature may include an embodiment in which the first feature directly contacts the second feature, and may also include an embodiment in which an additional feature is formed between the first feature and the second feature so that the first feature does not directly contact the second feature.

In addition, terms such as “first” and “second” are used herein for purposes of description and are not intended to indicate or imply relative importance or significance or imply a number of technical features indicated. Therefore, a “first” or “second” feature may explicitly or implicitly comprise one or more features. Further, in the description, unless indicated otherwise, “a plurality of” refers to two or more.

Extensible markup language (XML) is a markup language that defines a set of rules for encoding documents in a format that is both human-readable and machine-readable. It is defined in the XML 1.0 Specification produced by the W3C, and several other related specifications, all free open standards.

The design goals of XML emphasize simplicity, generality, and usability over the Internet. It is a textual data format with strong support via Unicode for different human languages. Although the design of XML focuses on documents, it is widely used for the representation of arbitrary data structures, for example in web services.

An XML schema is a description of a type of XML document, typically expressed in terms of constraints on the structure and content of documents of that type, above and beyond the basic syntactical constraints imposed by XML itself. These constraints are generally expressed using some combination of grammatical rules governing the order of elements, Boolean predicates that the content must satisfy, data types governing the content of elements and attributes, and more specialized rules such as uniqueness and referential integrity constraints.

There are languages developed specifically to express XML schemas. The document type definition (DTD) language, which is native to the XML specification, is a schema language that is of relatively limited capability, but that also has other uses in XML aside from the expression of schemas. Two more expressive XML schema languages in widespread use are XML Schema (with a capital S) and RELAX NG.

The mechanism for associating an XML document with a schema varies according to the schema language. The association may be achieved via markup within the XML document itself, or via some external means.

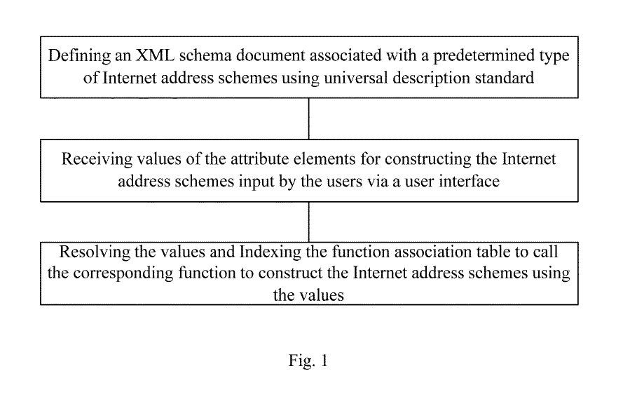

FIG. 1 shows a flow chart of a method for constructing Internet address schemes using XML, according to an embodiment.

In a first step, an XML schema associated with a predetermined type of Internet address schemes is defined using a universal description standard.

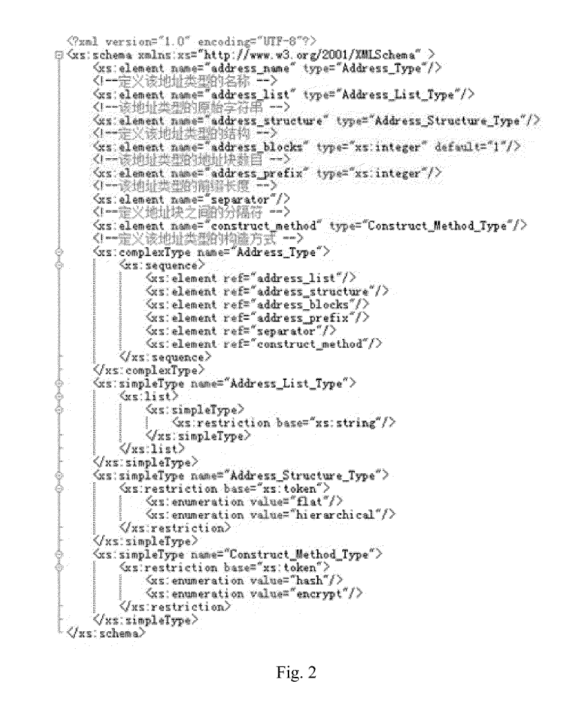

In the XML schema, semantics constraints are applied to attribute elements of Internet address schemes. FIG. 2 shows an example of the XML schema in this embodiment, in which the universal description standard is included. In this embodiment, the XML schema includes seven attribute elements, covering core attributes of constructing the Internet address schemes. The attribute elements include:

address_name, representing a name of the type of Internet address schemes, which is defined by users, such as, Internet protocol version 6 (IPv6), HIP, and AIP.

address_list, representing an original Internet address string, which is in a form of table and input by the users or automatically generated. For example, for IPv6, the original Internet address string is in an HEXBinary form, and for HIP and AIP, the original Internet address strings are public keys of HIP and AIP, which is in a form of string. In addition, restriction elements can be used to restrain a length and size of the original Internet address string.

address_structure, representing Internet address structure, which can be restrained by enumeration values and used for designating the Internet address schemes as a flat structure or a hierarchical structure.

address_blocks, representing the number of Internet address blocks, which is an integer with default value 1, that is, the Internet address schemes have flat structure and haven't divided into blocks.

address_prefix, representing a prefix length of the Internet address schemes, which is an integer and used for designating the prefix length of the Internet address schemes.

separator, representing a separator for connecting the Internet address blocks, such as “/”, “.”, and “:”.

construct_method, representing a function constructing method for the Internet address schemes, which is an enumeration type and stored in a function association table. In the function association table, a collection of function constructing methods and a collection of functions for constructing the Internet address schemes, each of which is associated with a corresponding function constructing method, are stored. The attribute element construct_method is used for calling the function for constructing the Internet address schemes by indexing the function association table.

The following Table 1 shows an example of the function association table.

TABLE 1

| Function constructing methods | |
|---|---|
| of the Internet address schemes | Functions |
| MD5_HASH | String MD5(string BaseAddress){......} |
| SHA1_HASH | String SHA1(string BaseAddress){......} |
| DES_ENCRYPT | String DES(string BaseAddress){......} |
| ...... | ...... |

For example, an IPv6 address is consisting of HEXBinary address blocks, an HIP address is constructed by hashing the original Internet address string, and another address may be constructed by encryption. The user can choose a function constructing method, and a corresponding function will be called by indexing the function association table.

To be compatible with potential function constructing methods that may be used for future types of the Internet address schemes, functions can be defined by the users for constructing the Internet address schemes. Accordingly, a name of a corresponding function constructing method of the Internet address schemes is required to input to the function association table and associated with the user-defined function. As such, the function can be called when the corresponding function constructing method is chosen by the users. Thus, a flexibility of constructing the Internet address schemes is increased.

In a second step, values of the attribute elements for constructing the Internet address schemes are input by the users via a user interface. The values are checked for, for example, correctness and completeness, according to the semantics constraints in the XML schema. If pass, the method goes to a third step, if no, the method remains in the second step for correcting the values.

In a third step, the values are resolved and the function association table is indexed for calling the corresponding function to construct the Internet address schemes using the values. The Internet address schemes can be a single address or an address string consisting of a series of addresses.

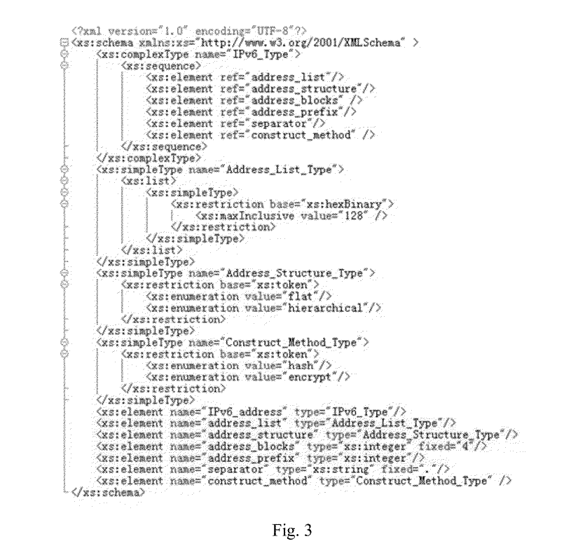

FIG. 3 shows an example of XML schema for IPv6 addresses. For other types of the Internet address schemes, the attribute elements can be amended accordingly.

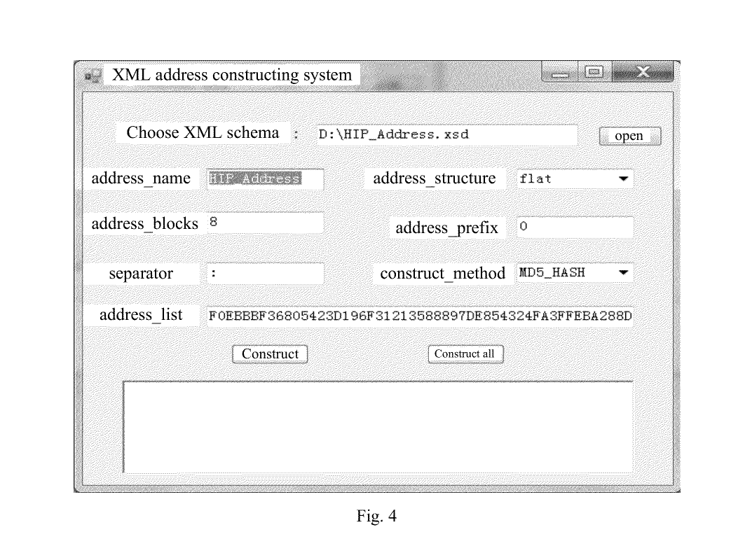

FIG. 4 shows the user interface for constructing the HIP addresses after the values are input but before the HIP addresses are finally constructed.

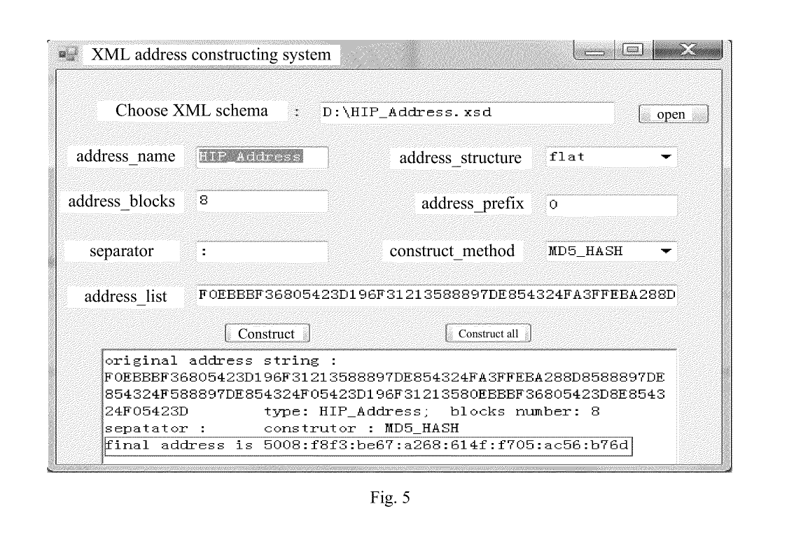

FIG. 5 shows the user interface for constructing the HIP addresses after the HIP addresses are constructed.

In this method, various types of the Internet address schemes are analyzed to obtain common attribute elements of current and future types of the Internet address schemes. Thus, a universal description standard with almost complete semantics constraints is provided to construct different types of the Internet address schemes. Efficiency is increased.

Reference throughout this specification to “an embodiment”, “some embodiments”, “one embodiment”, “an example”, “a specific examples”, or “some examples” means that a particular feature, structure, material, or characteristic described in connection with the embodiment or example is included in at least one embodiment or example of the disclosure. Thus, the appearances of the phrases such as “in some embodiments”, “in one embodiment”, “in an embodiment”, “an example”, “a specific examples”, or “some examples” in various places throughout this specification are not necessarily referring to the same embodiment or example of the disclosure. Furthermore, the particular features, structures, materials, or characteristics may be combined in any suitable manner in one or more embodiments or examples.

Although explanatory embodiments have been shown and described, it would be appreciated by those skilled in the art that changes, alternatives, and modifications may be made in the embodiments without departing from spirit and principles of the disclosure. Such changes, alternatives, and modifications all fall into the scope of the claims and their equivalents.

What is claimed is:

1. A method for constructing Internet protocol (IP) addresses using extensible markup language (XML), the method comprising:
defining an XML schema associated with a predetermined type of Internet address schemes using a universal description standard, the XML schema comprising attribute elements covering core attributes of constructing the Internet address schemes, the attribute elements comprising: construct_method, representing a function constructing method for the Internet address schemes, which is an enumeration type stored in a function association table, the function association table storing a collection of function constructing methods and a collection of functions for constructing the Internet address schemes, each of which is associated with a corresponding function constructing method;
inputting values of the attribute elements for constructing the Internet address schemes; and
resolving the values and calling the corresponding function to construct the Internet address schemes according to the values.

2. The method of claim 1, wherein the attribute elements in addition comprise:
address_name, representing a name of the type of Internet address schemes;
address_list, representing an original internet address string;
address_structure, representing internet address structure;
address_blocks, representing the number of internet address blocks;
address_prefix, representing a prefix length of the Internet address schemes; and
separator, representing a separator for connecting the internet address blocks.

3. The method of claim 2, wherein the attribute element address_name is defined by users.

4. The method of claim 2, wherein the attribute element address_list is defined by users or automatically generated.

5. The method of claim 2, wherein restriction elements are used to restrain a length and size of the original internet address string.

6. The method of claim 2, wherein the attribute element address_structure is restrained by enumeration values and used for designating the Internet address schemes as a flat structure or a hierarchical structure.

7. The method of claim 2, wherein the attribute element address_blocks is an inter with default value 1.

8. The method of claim 2, wherein the attribute element address_prefix is an integer and used for designating the prefix length of the Internet address schemes.

9. The method of claim 2, wherein the attribute element separator is selected from the group consisting of “/”, “.”, and “:”.

10. The method of claim 1, wherein the function is defined by the users and associated with a corresponding function constructing method in the function association table.

11. The method of claim 1, wherein semantics constraints are applied to the attributes element of the Internet address schemes, the method further comprises:
checking the values for correctness and completeness according to semantics constraints in the schema, if pass, the method going to the resolving step and if no the method remaining in the inputting step.
